(19) United States
(12) Patent Application Publication
(10) Pub. No.: US 2019/0102597 A1
(43) Pub. Date: Apr. 4, 2019

(54) METHOD AND ELECTRONIC DEVICE OF PERFORMING FINGERPRINT RECOGNITION

(71) Applicant: Lenovo (Beijing) Co., Ltd., Beijing (CN)

(72) Inventors: Zhengliu LU, Beijing (CN); Minggui QIAN, Beijing (CN)

(21) Appl. No.: 16/148,264

(22) Filed: Oct. 1, 2018

(30) Foreign Application Priority Data
Sep. 30, 2017 (CN) 201710918711.0

(51) Int. Cl. G06K 9/00; G09G 5/10

(52) U.S. Cl. CPC G06K 9/0004; G09G 5/10; G09G 2320/0626; G09G 2360/144; G09G 2354/00

(57) ABSTRACT

A method and an electronic device of performing fingerprint recognition are provided. The method of performing the fingerprint recognition comprises: receiving a trigger instruction to call a fingerprint-recognition element of an electronic device; and in response to receiving the trigger instruction, activating one or more pixel units of a display screen of the electronic device to provide light at a fingerprint detection area of the display screen; detecting a fingerprint of a user of the electronic device at the fingerprint-detection area of the display screen; and determining whether or not the user is an authorized user of the electronic device from the fingerprint of the user as detected.

### CROSS-REFERENCES TO RELATED APPLICATIONS

This application claims priority of Chinese Patent Application No. 201710918711.0, filed on Sep. 30, 2017, the entire contents of which are hereby incorporated by reference.

### FIELD OF THE DISCLOSURE

The present disclosure generally relates to the field of smart device control and, more particularly, relates to a method and an electronic device of performing fingerprint recognition.

### BACKGROUND

Fingerprint recognition has become a synonym for biometric identification due to fingerprint's lifetime invariance, uniqueness and convenience in collection. A fingerprint is the friction ridges on the epidermis of a human finger. The major minutia features of fingerprint ridges include ridge ending, bifurcation, and short ridge.

Optical fingerprint recognition is one common method employed by fingerprint recognition. The operating principle of optical fingerprint imaging is described as follows: a light source is placed under a display screen, and the light source is engineered to emit lights outside the display screen; when a user touches the display screen, the light blocked by the user's finger is partially reflected back into the display screen and passes through a pixel layer of the display screen to reach an optical fingerprint sensor; and the system can identify the user's fingerprint in accordance with the difference in optical path lengths of the reflected lights.

In existing technologies, when electronic devices are set with the fingerprint-recognition element, the fingerprint-recognition element is usually configured separately from the display screen, i.e., the fingerprint-recognition element and the display screen are isolated and become two separate parts. As a result, the fingerprint-recognition element needs to occupy additional structural space of the electronic devices, which cannot satisfy the user's demand in pursing the compact form factor, thus degrading user experience.

The disclosed processing method and electronic device thereof are directed to solve one or more problems set forth above and other problems.

### BRIEF SUMMARY OF THE DISCLOSURE

One aspect of the present disclosure provides a processing method. The method of performing fingerprint recognition comprises: receiving a trigger instruction to perform fingerprint recognition; and in response to receiving the trigger instruction, activating one or more pixel units of a display screen of the electronic device to provide light at a fingerprint detection area of the display screen; detecting a fingerprint of a user of the electronic device at the fingerprint-detection area of the display screen; and determining whether or not the user is an authorized user of the electronic device from the fingerprint of the user as detected.

Another aspect of the present disclosure provides an electronic device. The electronic device comprises: a display screen having a fingerprint detection area; a fingerprint detection device comprised in the display screen; and a processor coupled to the display screen and the fingerprint recognition device. In response to receiving a trigger instruction to perform fingerprint recognition, the processor is operable to: activate one or more pixel units of the display screen to provide light at a fingerprint detection area of the display screen; activate the fingerprint detection device to detect a fingerprint of a user of the electronic device at the fingerprint-detection area of the display screen; and determine whether or not the user is an authorized user of the electronic device from the fingerprint as detected.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of a method of performing fingerprint recognition consistent with disclosed embodiments;

FIG. 2 illustrates a flow chart of another method of performing the fingerprint recognition consistent with disclosed embodiments;

FIG. 3 illustrates a flow chart of another method of performing the fingerprint recognition consistent with disclosed embodiments;

FIG. 4 illustrates a flow chart of another method of performing the fingerprint recognition consistent with disclosed embodiments;

FIG. 5 illustrates a flow chart of another method of performing the fingerprint recognition consistent with disclosed embodiments;

FIG. 6 illustrates a flow chart of another method of performing the fingerprint recognition consistent with disclosed embodiments; and

FIG. 7 illustrates a schematic block diagram of an electronic device consistent with disclosed embodiments.

### DETAILED DESCRIPTION

The following describes the present disclosure in detail with reference to the accompanying drawings.

It should be understood that various modifications may be made to the embodiments disclosed herein. Therefore, the following description should not be construed as limiting the scope of the invention, but merely as examples of the embodiments consistent with the present disclosure. Those skilled in the art would envision other modifications within the scope and spirit of the present disclosure.

The accompanying drawings, which are incorporated in and constitute a part of the specification, illustrate embodiments of the present disclosure, and together with the general description of the disclosure given above and the detailed description of the embodiments given below serve to explain the principle of the present disclosure.

These and other features of the present disclosure will become apparent from the following description of preferred forms of the embodiments given as non-limiting examples with reference to the accompanying drawings.

It should also be understood that although the present disclosure has been described with reference to certain specific examples, those skilled in the art can certainly implement many other equivalent forms of the present disclosure, which have the features recited in the claims and hence are located within the scope of this protection limited hereby.

The above and other aspects, features, and advantages of the present disclosure will become more apparent in view of the following detailed description in conjunction with the accompanying drawings.

Hereafter, specific embodiments of the present disclosure will be described with reference to the accompanying drawings. However, it should be understood that the disclosed embodiments are merely examples of the present disclosure, which may be implemented in various manners. Well-known and/or repetitive functions and structures are not descripted in detail to avoid unnecessary or superfluous details that would obscure the disclosure. Hence, specific structural or functional details disclosed herein are not intended to be limiting, but merely as a basis for the claims and as a representative basis for instructing those skilled in the art to variously employ the present disclosure in any literally appropriate, detailed structure.

The present description may use the phrases, e.g., “in one embodiment”, “in another embodiment”, “in yet another embodiment”, or “in other embodiments”, which can refer to one or more of the same or different embodiments consistent with the present disclosure.

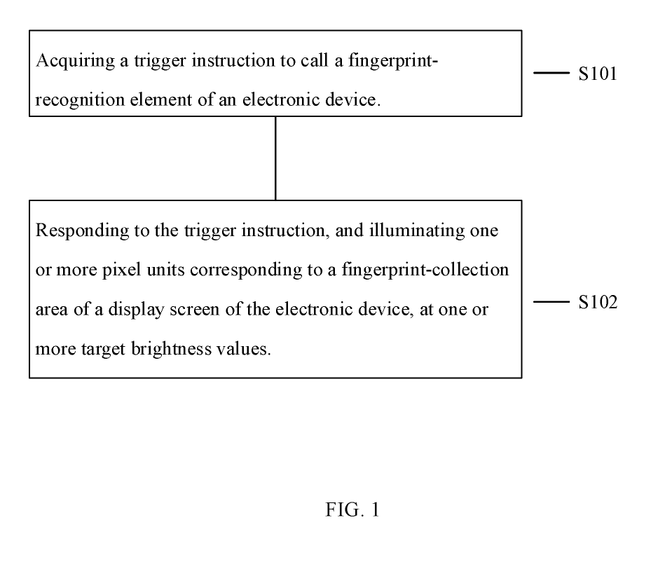

FIG. 1 illustrates a flow chart of a method of performing fingerprint recognition consistent with disclosed embodiments. As shown in FIG. 1, in step S101, a trigger instruction is received to call a fingerprint-recognition element (also referred to as a fingerprint detection device) of an electronic device for performing the fingerprint recognition. For example, when a user clicks any operating button on the electronic device or any place on a display screen, a system may generate the trigger instruction according to the user's operation.

Further, in step S102, in response to receiving the trigger instruction, one or more pixel units corresponding to a fingerprint-detection area (also referred to as a fingerprint-collection area) of the display screen of the electronic device are illuminated at a target brightness. That is, the one or more pixel units are activated to provide light at the fingerprint detection area of the display screen.

In one embodiment, the activated one or more pixel units corresponding to the fingerprint-detection area of the display screen of the electronic device may serve as the light source for the fingerprint-recognition element. As such, when a finger is placed at the fingerprint-detection area, the activated one or more pixel units pointed by the finger may generate lights for reflection. A recognition member of the fingerprint-recognition element may be mounted under the display screen, and may correspond to (or face) the fingerprint-detection area. The fingerprint-recognition member may be used to receive the reflected lights for collecting a fingerprint.

In one embodiment, the fingerprint-detection area may be part or all of the display area of the display screen, which is not limited herein. In addition, before the system receives the trigger instruction to activate the one or more pixel units corresponding to the fingerprint-detection area of the display screen, at the target brightness, the display screen may be in a non-lighting state (i.e., in a black screen state) by default. If the display screen has been already illuminated in a lighting state before the system receives the trigger instruction, at this time, the current brightness of the above pixel units may be changed to the target brightness. This adaptive adjustment also falls within the scope of the present disclosure.

Further, in some embodiments, a fingerprint of a user of the electronic device can be detected at the fingerprint-detection area of the display screen, and whether or not the user is an authorized user of the electronic device can be determined from the fingerprint of the user as detected.

By applying the method of performing the fingerprint recognition of the present disclosure, the electronic devices are not needed by the user to have another fingerprint-detection area outside the display screen. The system may automatically adjust part or all of the display area of the display screen to be the fingerprint-detection area according to the user's instruction, and may activate the one or more pixel units at the fingerprint-detection area of the display screen, at the target brightness, to serve as the light source for the fingerprint recognition. The user can complete the fingerprint recognition via the display screen in a more convenient and faster manner. And the structural space of the electronic devices can be saved, thus allowing the electronic devices to be made thinner and improving the user experience.

Moreover, the disclosed method of activating the one or more pixel units corresponding to the fingerprint-detection area of the display screen of the electronic device, at the target brightness, is not unique. The following embodiments will be described in detail.

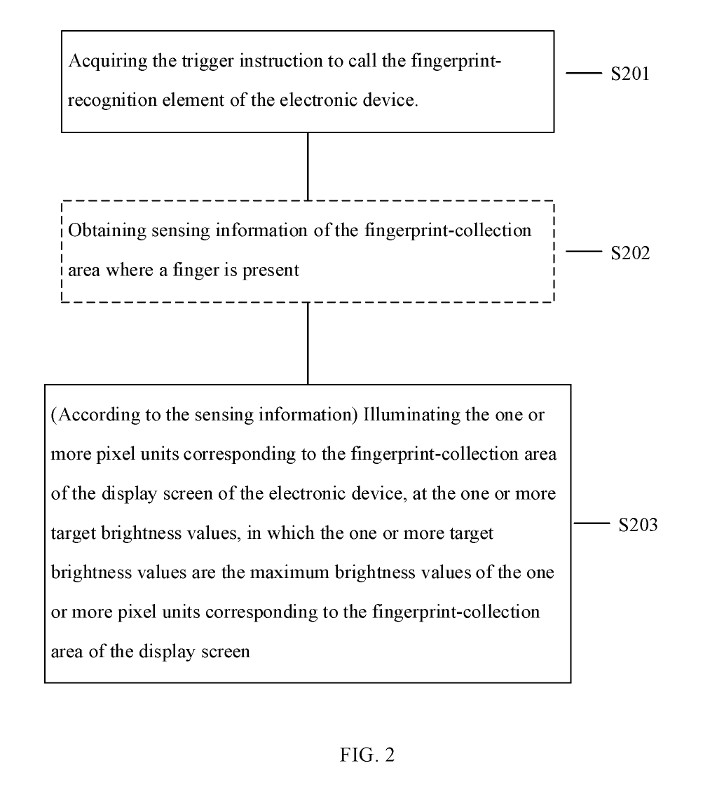

FIG. 2 illustrates a flow chart of a method of performing fingerprint recognition consistent with disclosed embodiments. As shown in FIG. 2, in step S201, the trigger instruction is received/acquired to call the fingerprint-recognition element of the electronic device.

Further, in step S203, the one or more pixel units corresponding to the fingerprint-detection area of the display screen of the electronic device are illuminated at a maximum brightness. That is, the one or more pixel units corresponding to the fingerprint-detection area can be activated to provide light at the maximum brightness. The target brightness is the maximum brightness of the one or more pixel units, corresponding to the fingerprint-detection area of the display screen. That is, once the system receives the trigger instruction, the system may activate the one or more pixel units corresponding to the fingerprint-detection area of the display screen, at the maximum brightness (by default, the display screen has not been illuminated beforehand).

Thus, the current brightness of the one or more pixel units may become the maximum brightness, while the pixel units of the rest parts of the display screen may be activated with an original current. If the display screen has been already illuminated beforehand, the current brightness of the one or more pixel units corresponding to the fingerprint-detection area of the display screen may be adjusted to the maximum brightness, while the pixel units of the rest parts of the display screen may be maintained to illuminate at the original brightness.

Alternatively, instead of receiving the trigger information at the beginning, the method may start with detecting the fingerprint of the user of the electronic device at the fingerprint detection area of the display screen, by obtaining sensing information of the fingerprint-detection area where a finger is present (S202). That is, after the user places the finger on the fingerprint-detection area of the display screen, the system may sense such an operation from the user and correspondingly generate sensing information.

Further, after detecting the fingerprint of the user of the electronic device at the fingerprint detection area of the display screen, according to the sensing information, the one or more pixel units corresponding to the fingerprint-detection area of the display screen of the electronic device are illuminated at the maximum brightness (S203).

The target brightness is the maximum brightness of the one or more pixel units corresponding to the fingerprint-detection area of the display screen. That is, the fingerprint-collection element is called by the user through clicking or touching on the fingerprint-detection area of the display screen. The system may generate the trigger instruction according to the user's operation on the fingerprint-detection area, and may concurrently generate the sensing information. Afterwards, according to the generated trigger instruction and sensing information, the system may implement activation of the one or more pixel units or adjustment of the brightness. Also, the user may first illuminate the display screen in other manners, and then may place the finger on the fingerprint-detection area of the display screen for the system to generate the sensing information. The courses of the activation of the one or more pixel units and the adjustment of the brightness for the one or more pixel units are identical with the courses described above, which are not repeated herein.

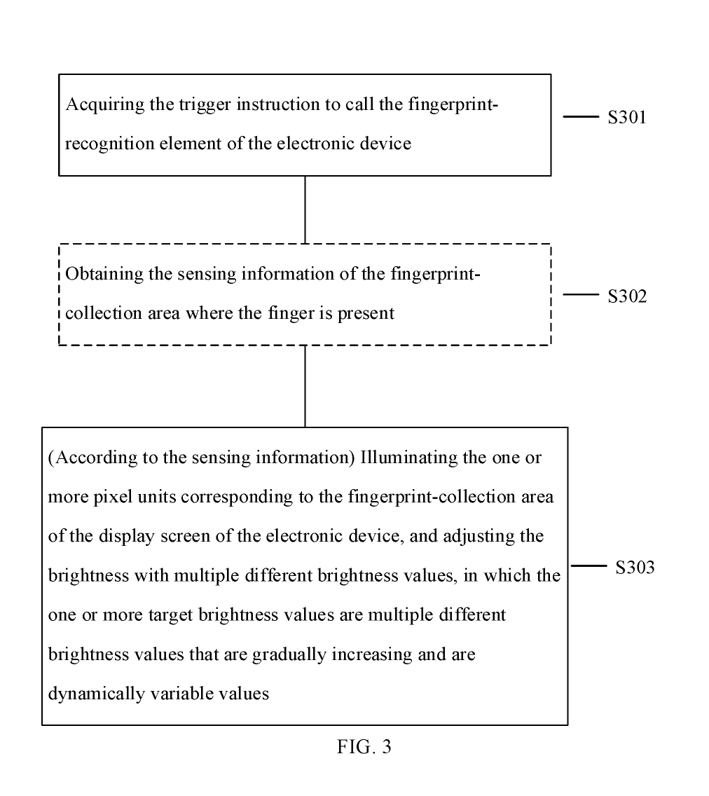

FIG. 3 illustrates a flow chart of a method of performing the fingerprint recognition consistent with disclosed embodiments. As shown in FIG. 3, in step S301, the trigger instruction is received/acquired to call the fingerprint-recognition element of the electronic device.

Further, in step S303, the one or more pixel units corresponding to the fingerprint-detection area of the display screen of the electronic device are illuminated and adjusted with multiple different brightnesses. That is, the one or more pixel units can be activated to provide light at the multiple different brightnesses. The one or more target brightnesses are the multiple different brightnesses that are gradually increasing, and are dynamically variable values.

This implementation means that, after receiving the trigger instruction, the system may first activate the one or more pixel units corresponding to the fingerprint-detection area of the display screen, at a minimum brightness or a first brightness, and may maintain the illumination for a period of time. That is, the one or more pixel units may display for a period of time, e.g. 2 s, 3 s, etc., at such a brightness, and the system may proceed to re-activate the above one or more pixel units at another brightness slightly higher than the minimum brightness or the first brightness. Alternatively, the system may raise the brightness on the basis of the minimum brightness or the first brightness, and may make the one or more pixel units display at a second brightness higher than the first brightness for a period of time, afterwards, the system may continue to increase the brightness for the one or more pixel units, and so on.

While the one or more pixel units are displaying at a certain brightness, the recognition member of the fingerprint-recognition element may detect the fingerprint. After the detected fingerprint is qualified, the system may stop increasing the brightness for the one or more pixel units. Since light intensities vary with different environments, according to different environments, the electronic device may require different light intensities to complete the fingerprint detection. Hence, when the system is adjusting the brightness for the above one or more pixel units, the recognition member may have completed the fingerprint detection before the one or more pixel units reach the maximum brightness. Compared with the method of activating the one or more pixel units at the maximum brightness in the first place, the method of performing the fingerprint recognition disclosed in this embodiment can save more power consumption and also can extend the lifetime for the above one or more pixel units.

Alternatively, instead of receiving the trigger instruction at the beginning, the system may start with detecting the fingerprint of the user of the electronic device at the fingerprint detection area of the display screen by obtaining the sensing information of the fingerprint-detection area where the finger is present (S302). That is, after the user places the finger on the fingerprint-detection area of the display screen, the system may sense such an operation from the user and generate the sensing information.

Further, after detecting the fingerprint of the user of the electronic device at the fingerprint detection area of the display screen, i.e., after obtaining the sensing information of the fingerprint-collection area where the finger is present, according to the sensing information, the one or more pixel units corresponding to the fingerprint-detection area of the display screen of the electronic device are activated and adjusted with multiple different brightnesses (S303). The one or more target brightnesses are the multiple different brightnesses that are gradually increasing, and are dynamically variable values. That is, only after the user places the finger on the fingerprint-detection area of the display screen, the system may activate the one or more pixel units corresponding to the fingerprint-detection area of the display screen. The activation method is identical with the activation method described above, which is not repeated herein.

Moreover, before the system obtains the trigger instruction, by default, the display screen may have not been illuminated (i.e., in the black screen state) in above methods. In one embodiment, if the display screen has been already illuminated in the lighting state before the system receives the trigger instruction, the system may adjust the current brightness of the one or more pixel units to be the minimum brightness or the preset starting brightness, and may proceed to adjust the brightness according to the above methods.

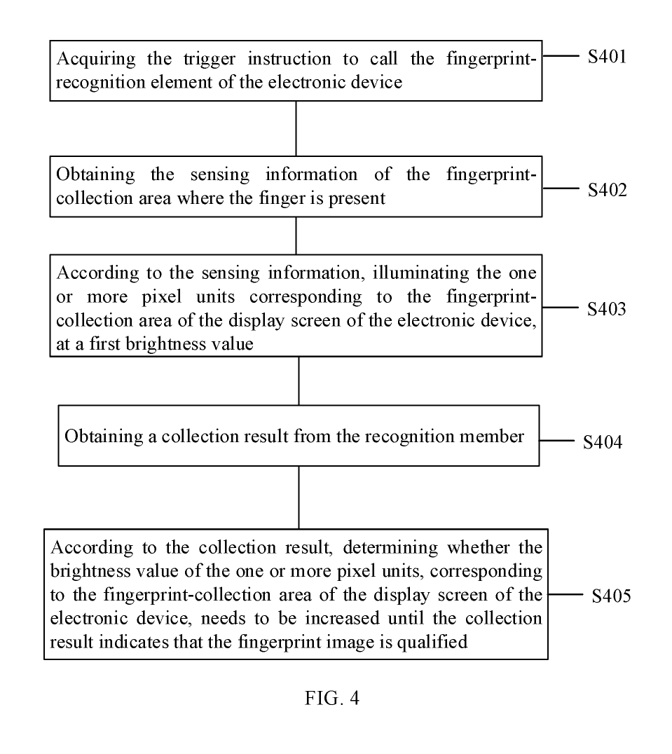

FIG. 4 illustrates a flow chart of a method of performing the fingerprint recognition consistent with disclosed embodiment. As shown in FIG. 4, at the beginning, the trigger instruction is received/acquired to call the fingerprint-recognition element of the electronic device (S401).

Further, after receiving the trigger instruction to call the fingerprint-recognition element of the electronic device, the fingerprint of the user of the electronic device is detected at the fingerprint-detection area of the display screen by obtaining the sensing information of the fingerprint-collection area (S402). That is, the user needs to place the finger on the fingerprint-detection area of the display screen, the trigger instruction is generated by the user through clicking or touching on the fingerprint-collection area of the display screen. Also, the user may illuminate the display screen in other manners before placing the finger on the fingerprint-detection area of the display screen.

Further, based on the fingerprint of the user as detected, i.e., according to the sensing information, the one or more pixel units corresponding to the fingerprint-detection area of the display screen of the electronic device are activated at a first brightness (S403).

Further, after activating the above one or more pixel units at the first brightness, a collection result is obtained from the recognition member (S404). That is, the collection result may be a fingerprint image formed after the recognition member collects the fingerprint.

Further, after obtaining the collection result from the fingerprint-recognition element, according to the collection result, in step S405, it is determined whether the quality of the detected fingerprint of the user is sufficient for recognition, i.e., it is determined whether or not the brightness of the one or more pixel units corresponding to the fingerprint-detection area of the display screen of the electronic device, needs to be increased until the collection result indicates that the fingerprint image is qualified. That is, the target brightnesses are dynamically variable values, and range between the first brightness and the N-th brightness in the course of increasing the brightness for the one or more pixel units, where N is an integer larger than or equal to zero.

The difference between the disclosed method here and the one shown in FIG. 3 may include that the adjustment of the brightness by the system in the embodiments shown in FIG. 3 for the one or more pixel units corresponding to the fingerprint-detection area of the display screen is not in accordance with the collection result from the recognition member. In contrary, the adjustment of the brightness by the system in this embodiment for the one or more pixel units is based on the collection result from the recognition member. Compared to the embodiments shown in FIG. 3, the adjustment for the one or more pixel units in this embodiment is more reliable.

In one embodiment, if the collection result is not qualified (e.g., the collected fingerprint image is not sufficiently clear), according to the collection result indicating that the fingerprint image is not qualified, the system may increase the first brightness of the one or more pixel units corresponding to the fingerprint-detection area of the display screen of the electronic device, to a second brightness. For example, the one or more pixel units may be first activated at the first brightness. If the first brightness fails to satisfy the recognition member for collecting a high-quality fingerprint, the system may add a preset brightness based on the first brightness value, and may make the current brightness of the above one or more pixel units become the second brightness. If the second brightness value still fails to satisfy the recognition member for collecting the high-quality fingerprint, the system may add another preset brightness based on the second brightness, and may make the current brightness of the above one or more pixel units become the third brightness, and so on.

In another embodiment, the preset brightness may be a definite value, or may be self-determined by the system in accordance with the current degree to which the fingerprint-collection result fails to satisfy, thus allowing the brightness of the above one or more pixel units to satisfy the recognition member for collecting the high-quality fingerprint as quickly as possible, and thus improving the efficiency in fingerprint detection as well as saving the power consumption.

In one embodiment, if the collection result is qualified (i.e., the fingerprint image currently collected is clear enough to meet the requirements for detecting the fingerprint in the subsequent steps), according to the collection result indicating that the fingerprint image is qualified, the system may selectively maintain the current brightness for the one or more pixel units corresponding to the fingerprint-detection area of the display screen of the electronic device. Alternatively, according to the collection result indicating that the fingerprint image is qualified, the system may selectively turn off the one or more pixel units corresponding to the fingerprint-detection area of the display screen of the electronic device.

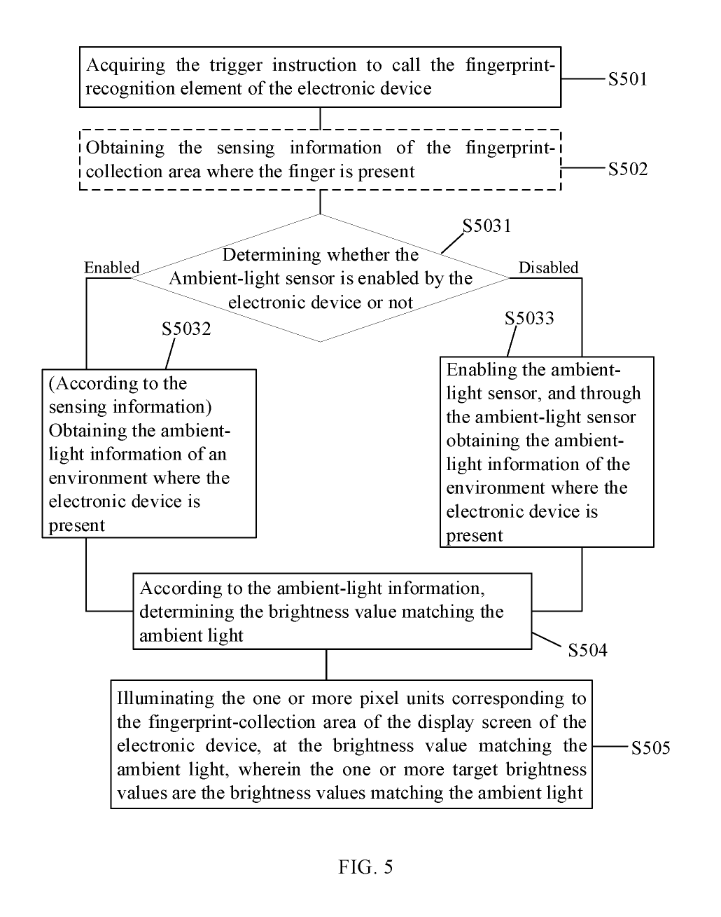

FIG. 5 illustrates a flow chart of a method of performing the fingerprint recognition consistent with disclosed embodiments. As shown in FIG. 5, at the beginning, the trigger instruction is received to call the fingerprint-recognition element of the electronic device (S501).

Further, after acquiring the trigger instruction to call the fingerprint-recognition element of the electronic device, ambient-light information of an environment, where the electronic device is located, is obtained (S503).

Further, after obtaining the ambient-light information of the environment where the electronic device is present, according to the ambient-light information, the brightness matching the ambient light is determined (S504). In practice, a database may be selectively created to establish a matching relationship between the ambient-light information and the brightness of the one or more pixel units. By searching the database according to the obtained ambient-light information, the brightness matching the ambient-light information may be retrieved.

Further, after determining the brightness value matching the ambient light according to the ambient-light information, the one or more pixel units corresponding to the fingerprint-detection area of the display screen of the electronic device are illuminated at the brightness matching the ambient light (S505). That is, the one or more pixel units can be activated to provide light at the brightness matching the ambient light. The target brightness is the brightness matching the ambient light.

Alternatively, at the beginning, the trigger instruction is received to call the fingerprint-recognition element of the electronic device (S501).

Further, after receiving the trigger instruction to call the fingerprint-recognition element of the electronic device, the system may obtain the sensing information of the fingerprint-detection area where the finger is present (S502).

Further, after obtaining the sensing information of the fingerprint-detection area where the finger is present, according to the sensing information, ambient-light information of an environment, where the electronic device is located, is obtained. That is, only after the user places the finger on the fingerprint-detection area of the display screen, the system may receive the sensing information to further obtain the ambient-light information.

Further, after obtaining the ambient-light information of the environment where the electronic device is located, according to the ambient-light information, the brightness matching the ambient light is determined (S504).

Further, after determining the brightness value matching the ambient light, the one or more pixel units corresponding to the fingerprint-detection area of the display screen of the electronic device are activated at the brightness matching the ambient light (S505). The target brightness is the brightness matching the ambient light.

In one embodiment, an ambient-light sensor may be configured to obtain the ambient-light information. In this embodiment, the method of obtaining the brightness matching the ambient-light information, according to the ambient-light information, for the one or more pixel units corresponding to the fingerprint-detection area of the display screen, and the method of adjusting the brightness for the one or more pixel units according to such a brightness can significantly improve the efficiency of adjusting the brightness for the above one or more pixel units, can save more power consumption, and also can remarkably extend the lifetime of the one or more pixel units.

Further, referring to FIG. 5, the step of obtaining the ambient-light information of the environment where the electronic device is located may further include sub-steps described as follows.

As shown in FIG. 5, in Step S5031, it is determined whether or not the ambient-light sensor is enabled by the electronic device. That is, it is determined whether or not the ambient-light sensor can be called by the electronic device.

Further, if it is determined that the ambient-light sensor is enabled, according to the status result indicating the ambient-light sensor is enabled, the ambient-light information sensed by the ambient-light sensor will be obtained (S5032). That is, if it is determined that the ambient-light sensor is turned on and can be called by the system, the ambient-light sensor will be operated to obtain the ambient-light information.

On the other hand, if it is determined that the ambient-light sensor is disabled, according to the status result indicating the ambient-light sensor is disabled, the ambient-light sensor will be enabled/activated to obtain the ambient-light information of the environment where the electronic device is located (S5033). That is, if it is determined that the ambient-light sensor is turned off and cannot be currently called by the system, the system will turn on the ambient-light sensor and enable the ambient-light sensor being called, and then will control the ambient-light sensor to obtain the ambient-light information.

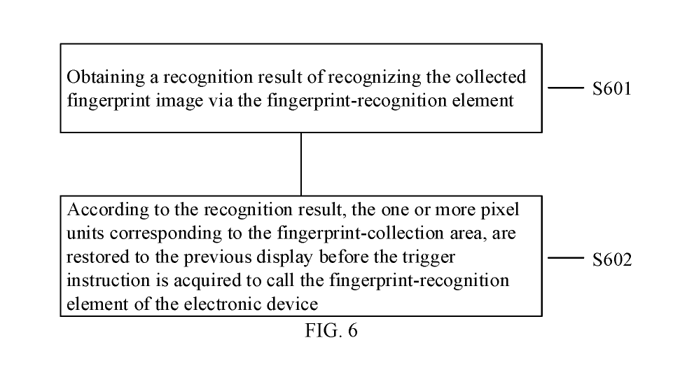

FIG. 6 illustrates a flow chart of a method of performing the fingerprint recognition consistent with disclosed embodiments. As shown in FIG. 6, at the beginning, a recognition result of recognizing the detected fingerprint image is obtained via the fingerprint-recognition element (S601). The recognition result is used to indicate whether or not the formed fingerprint-detection image according to the reflected lights can pass the verification.

Further, after it has determined whether or not the user is an authorized user of the electronic device, the one or more pixel units corresponding to the fingerprint-detection area are restored to the original brightness before the trigger instruction is received to call the fingerprint-recognition element of the electronic device. That is, no matter whether the recognition result is passed or not, once the fingerprint recognition is completed one time, the fingerprint detection and the fingerprint recognition are successfully completed one time. And regardless of the result, the one or more pixel units corresponding to the fingerprint-detection area of the display may respectively be restored to the previous brightness, just as the system has not received the trigger instruction.

For example, if the entire display screen has not been illuminated (i.e., in the black screen state) before the system receives the trigger instruction, then after the fingerprint recognition is completed one time, the above one or more pixel units will be no longer activated in the lighting state, and the entire display screen will continue to be restored to the black screen state. On the other hand, if the entire display screen has been illuminated in the lighting state and has been displaying various icons, then after the fingerprint recognition is completed one time, the above one or more pixel units will be restored to the original brightness for displaying various types of icons.

In addition to the disclosed method of performing the fingerprint recognition, the present disclosure also provides an electronic device capable of implementing the disclosed method of performing the fingerprint recognition.

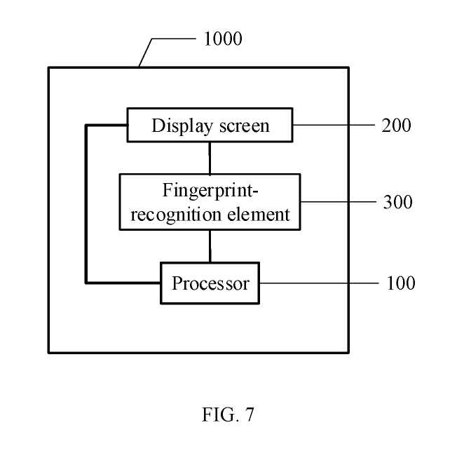

FIG. 7 illustrates a schematic block diagram of an electronic device consistent with disclosed embodiments. As shown in FIG. 7, the electronic device 1000 may include a display screen 200 having a fingerprint-detection area, and, a fingerprint-recognition element 300 comprised in the display screen 200, and a processor 100 coupled to the display screen 200 and the fingerprint-recognition element 300. Other appropriate components may also be included.

The display screen 200 may include the fingerprint-detection area and may output the data under the control of the processor 100.

The fingerprint-recognition element 300 may include a recognition member and the fingerprint-detection area. The display area may include the fingerprint-detection area.

The processor 100 may include one or more appropriate processors. In response to receiving a trigger instruction for performing the fingerprint recognition, the processor 100 is operable to: activate the one or more pixel units corresponding to the fingerprint-detection area of the display screen 200 of the electronic device 1000 to provide a light source at the fingerprint-detection area of the display screen 200; activate the fingerprint-recognition element 300 to detect a fingerprint of a user of the electronic device at the fingerprint-detection area of the display screen 200; and determine whether or not the user is an authorized user of the electronic device from the fingerprint as detected. Furthermore, the processor 100 may include multiple cores for multi-thread or parallel processing.

In one embodiment, the activated one or more pixel units corresponding to the fingerprint-detection area of the display screen 200 may serve as a light source of the fingerprint-recognition element 300. As such, when a finger is placed at the fingerprint-detection area, the activated one or more pixel units pointed by the finger can generate lights for reflection. The recognition member may be mounted under the display screen 200, and may correspond to (or face) the fingerprint-detection area. The recognition member may be used to receive the reflected lights for detecting a fingerprint.

Further, the fingerprint-detection area may be part or all of the display area of the display screen 200, which is not limited herein. Moreover, before the processor 100 receives the trigger instruction to activate the one or more pixel units, corresponding to the fingerprint-detection area of the display screen 200, at the target brightness, by default the display screen 200 may have not been illuminated (i.e., in a black screen state). If the display screen 200 has been already illuminated in a lighting state before the processor 100 receives the trigger instruction, then the current brightness of the above one or more pixel units will be changed to the target brightness. This adaptive adjustment also falls within the protection scope of the present disclosure.

Further, when the processor 100 performs the procedure of activating the one or more pixel units corresponding to the fingerprint-detection area of the display screen 200 of the electronic device 1000 at the target brightness, the disclosed method is not unique. The following embodiments can be referenced for details.

In one embodiment, the one or more pixel units corresponding to the fingerprint-detection area of the display screen of the electronic device are activated at a maximum brightness. The target brightness is the maximum brightness of the one or more pixel units corresponding to the fingerprint-detection area of the display screen 200. That is, once the processor 100 receives the trigger instruction, the processor 100 may activate the one or more pixel units corresponding to the fingerprint-detection area of the display screen 200 at the maximum brightness (by default, the display screen has not been illuminated beforehand). Thus, the current brightness of the one or more pixel units may become the maximum brightness, while the pixel units of the rest parts of the display screen 200 may be activated with an original current. If the display screen 200 has been already illuminated beforehand, the current brightness of the one or more pixel units corresponding to the fingerprint-detection area 620 of the display screen 200 may be adjusted to the maximum brightness, while the pixel units of the rest parts of the display screen 200 may be maintained to illuminate at the original brightness.

Alternatively, in another embodiment, at the beginning, the processor 100 may detect the fingerprint of a user of the electronic device at the fingerprint detection area of the display screen, by obtaining sensing information of the fingerprint-detection area where a finger is present.

Further, after obtaining the sensing information of the fingerprint-detection area where a finger is present, according to the sensing information, the processor 100 may activate the one or more pixel units corresponding to the fingerprint-detection area of the display screen 200 of the electronic device 1000 to a maximum brightness. The target brightness is the maximum brightness of the one or more pixel units corresponding to the fingerprint-detection area 620 of the display screen 200. That is, the fingerprint-collection element 300 is called by the user through clicking or touching on the fingerprint-detection area of the display screen 200. The processor 100 may generate the trigger instruction according to the user's operation on the fingerprint-detection area, and may concurrently generate the sensing information. Afterwards, according to the generated trigger instruction and sensing information, the processor 100 may activate the one or more pixel units or adjust the brightness. Also, the user may first illuminate the display screen 200 in other manners, and then may place the finger on the fingerprint-detection area of the display screen 200 for the processor 100 to generate the sensing information. The courses of the activation of the one or more pixel units and the adjustment of the brightness for the one or more pixel units are identical with the courses described above, which are not repeated herein.

In one embodiment, the processor 100 may adjust the one or more pixel units corresponding to the fingerprint-detection area of the display screen 200 of the electronic device 1000 at multiple different brightnesses. The target brightnesses are the multiple different brightnesses that are gradually increasing, and are dynamically variable values. This implementation means that, after receiving the trigger instruction, the processor 100 may first activate the one or more pixel units corresponding to the fingerprint-detection area of the display screen 200 at a minimum brightness or a first brightness, and may maintain the illumination for a period of time. That is, the one or more pixel units may display for a period of time, e.g. 2 s, 3 s, etc., at such a brightness, and the processor 100 may proceed to re-activate the above one or more pixel units at another brightness slightly higher than the minimum brightness or the first brightness. Alternatively, the processor 100 may raise the brightness on the basis of the minimum brightness or the first brightness, and may make the one or more pixel units display at a second brightness higher than the first brightness for a period of time, afterwards, the processor 100 may continue to increase the brightness for the one or more pixel units, and so on.

Alternatively, in another embodiment, the processor 100 may start with detecting the fingerprint of a user of the electronic device at the fingerprint detection area of the display screen, by obtaining the sensing information of the fingerprint-detection area where the finger is present. That is, after the user places the finger on the fingerprint-detection area of the display screen 200, the processor 100 may sense such an operation from the user and generate the sensing information.

Further, after obtaining the sensing information of the fingerprint-detection area where the finger is present, according to the sensing information, the processor 100 may activate and adjust the one or more pixel units corresponding to the fingerprint-detection area of the display screen 200 of the electronic device 1000 at multiple different brightnesses. The target brightnesses are the multiple different brightnesses that are gradually increasing, and are dynamically variable values.

In one embodiment, at the beginning, the processor 100 may detect the fingerprint of a user of the electronic device at the fingerprint detection area of the display screen, by obtaining the sensing information of the fingerprint-detection area where the finger is present. That is, the user needs to place the finger on the fingerprint-detection area of the display screen 200.

Further, after obtaining the sensing information of the fingerprint-detection area where the finger is present, based on the fingerprint of the user as detected, the processor 100 may activate the one or more pixel units corresponding to the fingerprint-detection area of the display screen 200 of the electronic device 1000 at a first brightness.

Further, after activating the above one or more pixel units at the first brightness, a collection result is obtained from the recognition member. That is, the collection result may be a fingerprint image formed after the recognition member collects the fingerprint.

Further, after obtaining the collection result from the fingerprint-recognition element 300, according to the collection result, it is determined whether the quality of the detected fingerprint of the user is sufficient for recognition (i.e., it is determined whether or not the brightness value of the one or more pixel units corresponding to the fingerprint-detection area of the display screen 200 of the electronic device 1000, needs to be increased until the collection result indicates that the fingerprint image is qualified). That is, the target brightnesses are dynamically variable values, and range between the first brightness and the N-th brightness in the course of increasing the brightness for the one or more pixel units, where N is an integer larger than or equal to zero.

The difference, between the disclosed method here and the one described above, may include that the adjustment of the brightness by the processor 100 in above embodiments for the one or more pixel units corresponding to the fingerprint-detection area of the display screen 200 is not in accordance with the collection result, obtained from the recognition member. In contrary, the adjustment of the brightness by the processor 100 in this embodiment for the above one or more pixel units is based on the collection result, obtained from the recognition member. Compared to the above-mentioned embodiments, the adjustment for the above one or more pixel units in this embodiment is more reliable.

In one embodiment, if the collection result is not qualified (e.g., the collected fingerprint image is not sufficiently clear), according to the collection result indicating that the fingerprint image is not qualified, the processor 100 may increase the first brightness of the one or more pixel units corresponding to the fingerprint-detection area of the display screen 200 of the electronic device 1000, to a second brightness. For example, the one or more pixel units may be first activated at the first brightness. If the first brightness fails to satisfy the recognition member for collecting a high-quality fingerprint, the processor 100 may add a preset brightness based on the first brightness, and may make the current brightness of the above one or more pixel units become the second brightness. If the second brightness value still fails to satisfy the recognition member for collecting the high-quality fingerprint, the processor 100 may add another preset brightness based on the second brightness, and may make the current brightness of the above one or more pixel units become the third brightness, and so on.

In another embodiment, the preset brightness value may be a definite value, or may be self-determined by the processor 100 in accordance with the current degree to which the fingerprint-collection result fails to satisfy, thus allowing the brightness of the above one or more pixel units to satisfy the recognition member for collecting the high-quality fingerprint as quickly as possible, and thus improving the efficiency in fingerprint collection as well as saving the power consumption.

In one embodiment, at the beginning, ambient-light information of an environment, where the electronic device 1000 is located, is obtained.

Further, after obtaining the ambient-light information of the environment where the electronic device 1000 is located, according to the ambient-light information, the brightness matching the ambient light is determined. In practice, a database may be selectively created to establish a matching relationship between the ambient-light information and the brightness of the one or more pixel units. By searching the database according to the obtained ambient-light information, the brightness matching the ambient-light information may be retrieved.

Further, after determining the brightness matching the ambient light according to the ambient-light information, the processor 100 may activate the one or more pixel units, corresponding to the fingerprint-detection area of the display screen 200 of the electronic device 1000, at the brightness matching the ambient light. The target brightness is the brightness matching the ambient light.

Alternatively, instead of obtaining the ambient-light information in the first place, the processor 100 may start with obtaining the sensing information of the fingerprint-detection area where the finger is present.

Further, after obtaining the sensing information of the fingerprint-detection area where the finger is present, according to the sensing information, the ambient-light information of an environment, where the electronic device 1000 is located, is obtained. That is, only after the user places the finger on the fingerprint-detection area of the display screen 200, the processor 100 may receive the sensing information to further obtain the ambient-light information.

Further, after obtaining the ambient-light information of the environment where the electronic device 1000 is located, according to the ambient-light information, the brightness matching the ambient light is determined.

Further, after determining the brightness matching the ambient light, the processor 100 may activate the one or more pixel units corresponding to the fingerprint-detection area of the display screen 200 of the electronic device 1000, at the brightness matching the ambient light. The target brightness is the brightness matching the ambient light.

In one embodiment, the ambient-light sensor may be configured to obtain the ambient-light information. In this embodiment, the method of obtaining the brightness matching the ambient-light information, according to the ambient-light information, for the one or more pixel units, corresponding to the fingerprint-detection area of the display screen 200; and the method of adjusting the brightness for the one or more pixel units according to such a brightness, can significantly improve the efficiency of adjusting the brightness for the above one or more pixel units, can save more power consumption, and also can remarkably extend the lifetime of the one or more pixel units.

Further, when the processor 100 obtains the ambient-light information of the environment where the electronic device 1000 is located, the procedure may include steps described as follows.

At the beginning, it is determined whether or not the ambient-light sensor is enabled by the electronic device 1000.

Further, if it is determined that the ambient-light sensor is enabled, according to the status result indicating the ambient-light sensor is enabled, the ambient-light information sensed by the ambient-light sensor will be obtained. That is, if it is determined that the ambient-light sensor is turned on and can be called by the processor 100, the ambient-light sensor will be operated to obtain the ambient-light information.

On the other hand, if it is determined that the ambient-light sensor is disabled, according to the status result indicating the ambient-light sensor is disabled, the ambient-light sensor will be activated to obtain the ambient-light information of the environment where the electronic device 1000 is located. That is, if it is determined that the ambient-light sensor is turned off and cannot be currently called by the processor 100, the processor 100 will turn on the ambient-light sensor and enable the ambient-light sensor being called, and then will control the ambient-light sensor to obtain the ambient-light information.

Further, the processor 100 disclosed in the present disclosure may be also used for obtaining a recognition result of recognizing the collected fingerprint image via the fingerprint-recognition element 300. The recognition result is used to indicate whether the formed fingerprint-collection image, according to the reflected lights, can pass the verification. Subsequently, according to the recognition result, the processor 100 may continue to be used for restoring the one or more pixel units corresponding to the fingerprint-detection area to the original brightness before the trigger instruction is received to call the fingerprint-recognition element 300 of the electronic device 1000. That is, no matter whether the recognition result is passed or not, once the fingerprint recognition is completed one time, the fingerprint detection and the fingerprint recognition are successfully completed one time. Regardless of the result, the one or more pixel units corresponding to the fingerprint-detection area of the display 200 may respectively be restored to the previous brightness, just as the processor 100 has not received the trigger instruction.

Full-screen electronic devices tend to integrate the fingerprint-recognition element 600 in the full-screen display area, for example, the fingerprint-recognition element 300 may be placed under the display screen 200. However, the optical fingerprint recognition needs to employ organic light-emitting diodes (OLEDs) as a light source. When a user or a conductor touches the fingerprint-detection area, the OLEDs at this area have to be first activated usually at the maximum brightness to avoid the interference from external lights, which can ensure a good recognition result. Since OLED materials have a limited lifetime, after long-term use, the brightness of the fingerprint-detection area would degrade, causing that during the normal display, the fingerprint-detection area becomes darker than the rest areas of the display screen.

In one embodiment, according to the ambient-light information sensed by the ambient-light sensor, the brightness of the OLEDs corresponding to the fingerprint-detection area may be adaptively self-adjusted without the need of always being displayed at the maximum brightness, thus reducing the impact of the optical fingerprint recognition on the lifetime of the OLED materials coupled to this area.

In another embodiment, the brightness of the OLEDs corresponding to the fingerprint-detection area may be adjusted gradually from low to high. Once the quality of the collected fingerprint image meets the requirement, the OLEDs corresponding to the fingerprint-detection area may be immediately turned off, or the brightness of the OLEDs corresponding to the fingerprint-detection area may be adjusted to the minimum brightness, thereby reducing the impact of the optical fingerprint recognition on the lifetime of the OLED materials coupled to this area.

The above embodiments are merely exemplary embodiments of the present disclosure and are not intended to limit the present disclosure. The protection scope of the present disclosure is defined by the claims. Those skilled in the art can make various modifications or equivalent replacements to the present disclosure within the spirit and scope of the present disclosure, and such modifications or equivalent replacements should also be regarded as falling within the protection scope of the present disclosure.

What is claimed is:

1. A method of performing fingerprint recognition, comprising:
receiving a trigger instruction to perform fingerprint recognition;
in response to receiving the trigger instruction, activating one or more pixel units of a display screen of the electronic device to provide light at a fingerprint detection area of the display screen;
detecting a fingerprint of a user of the electronic device at the fingerprint detection area of the display screen; and
determining whether or not the user is an authorized user of the electronic device from the fingerprint of the user as detected.

2. The method according to claim 1, wherein the step of activating the one or more pixel units of the display screen comprises:
activating the one or more pixel units of the display screen to a maximum brightness.

3. The method according to claim 1, wherein the step of activating the one or more pixel units of the display screen comprises:
detecting the fingerprint of the user of the electronic device at the fingerprint detection area of the display screen; and
activating the one or more pixel units of the display screen to a maximum brightness.

4. The method according to claim 1, wherein the step of activating the one or more pixel units of the display screen comprises:
adjusting an existing brightness of the one or more pixel units of the display screen.

5. The method according to claim 1, wherein the step of activating the one or more pixel units of the display screen comprises:
detecting the fingerprint of the user of the electronic device at the fingerprint detection area of the display screen; and
adjusting an existing brightness of the one or more pixel units of the display screen.

6. The method according to claim 1, wherein the step of activating the one or more pixel units of the display screen comprises:
detecting the fingerprint of the user of the electronic device at the fingerprint detection area of the display screen;
based on the fingerprint of the user as detected, activating the one or more pixel units of the display screen to a first brightness;
determining whether the quality of the detected fingerprint of the user is sufficient for recognition; and
if not, increasing the first brightness of the one or more pixel units of the display screen to a second brightness.

7. The method according to claim 1, wherein the step of activating the one or more pixel units of the display screen comprises:
obtaining ambient-light information of an environment where the electronic device is located;
according to the ambient-light information, determining a brightness matching the ambient light; and
adjusting an existing brightness of the one or more pixel units of the display screen to the brightness that matches the ambient light.

8. The method according to the claim 7, wherein the step of obtaining ambient-light information of an environment comprises:
activating an ambient-light sensor to obtain the ambient-light information of the environment.

9. The method according to claim 1, further comprising:
restoring the one or more pixel units of the display screen to the original brightness, after it has determined whether or not the user is an authorized user of the electronic device.

10. An electronic device, comprising:
a display screen having a fingerprint detection area;
a fingerprint detection device comprised in the display screen; and
a processor coupled to the display screen and the fingerprint detection device,
wherein in response to the processor receiving a trigger instruction to perform fingerprint recognition, the processor is operable to
activate one or more pixel units of the display screen to provide light at a fingerprint detection area of the display screen;
activate the fingerprint detection device to detecting a fingerprint of a user of the electronic device at the fingerprint detection area of the display screen; and
determine whether or not the user is an authorized user of the electronic device from the fingerprint as detected.

11. The electronic device according to claim 10, wherein:
the processor is further operable to activate the one or more pixel units corresponding to the fingerprint-detection area to provide light at a maximum brightness value.

12. The electronic device according to claim 10, wherein:
the processor is further operable to:
obtain sensing information of the fingerprint-detection area where the finger is present; and
according to the sensing information, activate the one or more pixel units corresponding to the fingerprint-detection area to provide light at a maximum brightness value.

13. The electronic device according to claim 10, wherein:
the processor is further operable to activate the one or more pixel units corresponding to the fingerprint-detection area to provide light at multiple different brightness values that are gradually increasing and are dynamically variable values.

14. The electronic device according to claim 10, wherein:
the processor is further operable to:
obtain sensing information of the fingerprint-detection area where the finger is present; and
according to the sensing information, activate the one or more pixel units corresponding to the fingerprint-detection area to provide light at multiple different brightness values that are gradually increasing and are dynamically variable values.
